(19) United States
(12) Patent Application Publication
(10) Pub. No.: US 2009/0308808 A1
(43) Pub. Date: Dec. 17, 2009

(54) System And Apparatus For Contaminant Remediation

(76) Inventor: Guy Sewell, Ada, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(21) Appl. No.: 12/140,533

(22) Filed: Jun. 17, 2008

(51) Int. Cl. C02F 3/00; C01B 3/00

(52) U.S. Cl. 210/610; 210/601; 205/742; 423/644; 210/192

(57) ABSTRACT

An apparatus and method for remediating an underground and/or aqueous contaminant. The method and apparatus utilize at least one electrically conductive surface to attract aqueous hydrogen ions. At the surface, the hydrogen ions interact with excess electrons to form dissolved hydrogen molecules. Dissolved hydrogen molecules provide a proton source for bioreactive material, either provided to or naturally occurring in the environment. The bioreactive material assists in the reduction of the contaminant into a less environmentally harmful compound.

### FIELD OF THE INVENTION

The present invention is directed to the field of contaminant removal from a water source.

### SUMMARY OF THE INVENTION

The invention is directed to a method for producing dissolved hydrogen molecules for bioremediation of water. The method comprises providing an electrically conductive surface, providing a continuous negative electric potential to the surface to attract hydrogen ions, and converting aqueous hydrogen ions to dissolved hydrogen molecules. The hydrogen ions are converted using the electron source provided by the negative electric potential.

Another embodiment of the invention is directed to a method for bioremediation of a contaminant plume in water. The method comprises producing dissolved hydrogen. The step of producing dissolved hydrogen comprises the steps of providing an electrically conductive surface, providing a continuous negative electric potential to the electrically conductive surface, and attracting aqueous hydrogen ions to the electrically conductive surface. Dissolved hydrogen molecules are then formed proximate the surface from the aqueous hydrogen ions, and a bioreactive material is provided proximate the conductive surface to facilitate bioremediation of the contaminant plume.

Another embodiment of the invention is directed to a method for reducing a halogenated organic compound in an aqueous plume. The method comprises providing a plurality of underground electrically conductive surfaces. A continuous negative electric potential is then produced at the conductive surface, such that the negative electric potential increases a concentration of aqueous hydrogen proximate at least one of the plurality of surfaces. Aqueous hydrogen ions are caused to form dissolved hydrogen molecules proximate the at least one surface, and a bioreactive material is provided proximate the at least one surface to reduce the halogenated organic compound.

Yet another embodiment of the invention is directed to a barrier for treating an aqueous contaminant plume by providing a location for hydrogen ions to form dissolved hydrogen molecules. The barrier comprises a plurality of electrically conductive surfaces and a means for generating a low voltage negative electrical charge at a selected plurality of conductive surfaces.

Another embodiment of the invention is directed to a barrier for treating an aqueous contaminant plume. The barrier comprises a low-voltage electric source and a plurality of electrically conductive surfaces. The plurality of conductive surfaces are adapted to receive a low-voltage negative charge from the source. The plurality of surfaces provide electrons to aqueous hydrogen ions proximate the surface.

### BRIEF DESCRIPTION OF THE DRAWINGS

FIG. 1 is a representative diagram of an apparatus for remediation of a contaminant plume in water, as shown in an embodiment for remediation of ground water.

FIG. 2 is an alternative embodiment of the apparatus of claim 1 adapted for remediation of surface water.

FIG. 3 is a demonstrative diagram of a microscopic process taking place at a charged surface located proximate hydrogen ions in solution.

FIG. 4 is a representation of a step-wise reduction of tricholoroethane to ethane and ethene.

### DETAILED DESCRIPTION

Contamination of water, both in aquifers and surface water, such as a stream or lake, may have significant consequences for both the users of that water and the environment as a whole. While natural attenuation of many contaminants will occur given enough time and soil or sediment in which the water may be remediated, the time required may not be feasible for the use of the water contemplated, either for the public or wildlife.

Chlorinated solvents were used and released to the environment in massive quantities during the mid 1900s. These contaminants have migrated through the subsurface and impacted ground water at thousands of sites. Their widespread use and unique properties have resulted in the chloroethenes being the most commonly detected class of organic contaminants in ground water. Chloroethenes can become human health hazards when processed in the liver, or via reductive dehalogenation in the environment.

Many remediation methods have developed to either treat the affected contamination or contain the contamination to prevent the damage it causes from spreading. Until recently, cleanup options have been limited because once these dense non-aqueous phase liquids have penetrated the water table and traveled downward, removal is extremely difficult. Existing methods have significant disadvantages which the present invention overcomes.

For example, the affected water may be pumped away from the site, treated, and returned without the contaminant present. This method requires external construction, such as a pipeline, and high pumping costs. One alternative is in situ chemical or biological treatment, where treatment chemicals are introduced into the water source. This method may require expensive installation and transportation of the chemicals to the site. Further, the method may require a secondary treatment procedure to remove the introduced chemicals from the water. Finally, it may be possible to dredge or excavate a contaminated area to remove contaminated water and soil/sediment for ex situ treatment or disposal. This method is effective at extracting the contaminant plume, but has a significant environmental impact due to the amount of material that must be removed.

Research suggests that molecular hydrogen (H₂) is a metabolic reductant in a process of microbial reduction of a contaminant such as a halogenated solvent. Therefore, a process that could directly provide molecular hydrogen in situ would be important for supporting remediation. Unfortunately, the most common method for creating molecular hydrogen in situ is through the electrolysis of water. While electrolysis produces large amounts of hydrogen, the hydrogen is created in gaseous form, which is not readily usable in the remediation process. Further, the process requires a large supply of energy to cause the reaction to begin. Finally, the introduction of large amounts of gaseous molecular hydrogen and oxygen into the environment is potentially dangerous, as both gasses are flammable. Use of electrolysis underground is particular dangerous, as gasses may collect until ignited. The present invention discloses a method for providing molecular hydrogen in a dissolved form for remediation forces, utilizing only low amounts of electrical current. Further, the present invention avoids having to inject hydrogen gas in situ, which does not provide dissolved hydrogen gas and requires further operating cost for the purchase and transportation of the hydrogen gas.

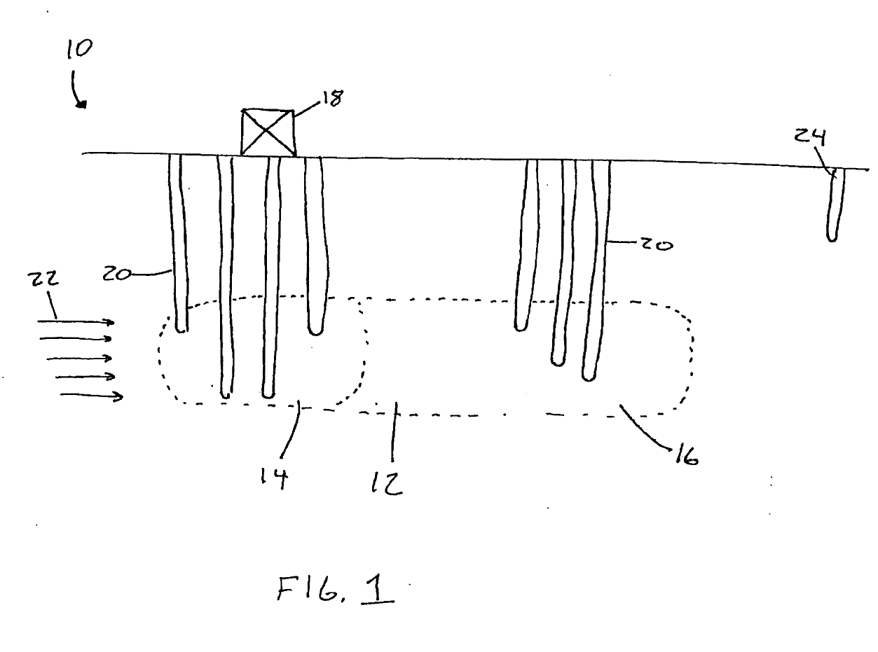

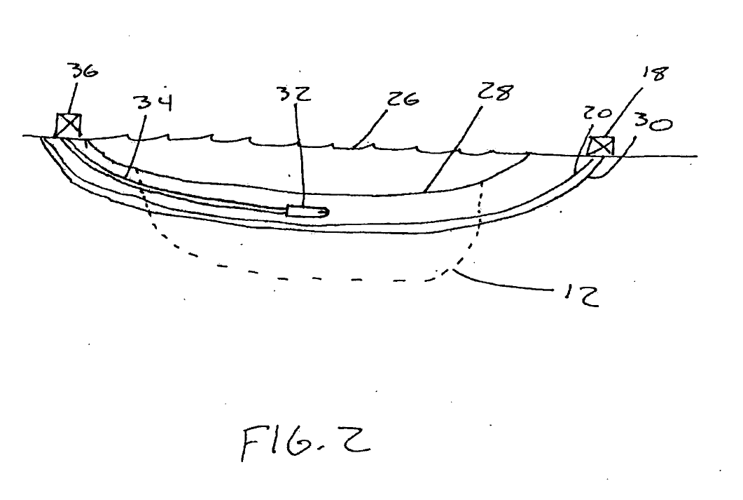

Turning now to the figures in general and FIG. 1 in particular, shown therein is a barrier 10 for remediation of a contaminant 12 in sediment and soil, in the presence of water. The contaminant 12 comprises a source area 14 and a dissolved plume 16. For exemplary purposes, the barrier 10 is shown remediating both the source area 12 and the plume 14. The contaminant 12 may be an organic or inorganic compound, such as a halogenated organic compound, a perchlorate, or a reducible inorganic compound. The barrier 10 comprises an electric source 18 and a plurality of electrically conductive surfaces 20. As shown, the plurality of electrically conductive surfaces 20 comprises a plurality of pylons. The electrically conductive surfaces 20 may also comprise alternative structures, such as a lattice, wires, or a similar means depending on the needs of the particular application. For instance, in a groundwater contamination scenario as the one shown in FIG. 1, pylons 20 may be more appropriate. If surface water is in need of remediation, wires or a lattice grid may be more appropriate as shown in FIG. 2. The conductive surfaces 20 may be composed of iron or any conductive material capable of supporting a stable negative potential suitable for this application.

With continued reference to FIG. 1, the plurality of pylons 20 is placed in an arrangement around the source area 14 such that migration of the contaminant 12 from the source area to a previously uncontaminated area is prevented. Pylons 20 are further placed along the path of migration 22, along which the contaminant plume 16 would extend. These pylons 20 may be placed in a substantially co-planar arrangement, effectively providing a barrier to continued contaminant migration. Further, wood chips (not shown) or other absorbent material may be used in conjunction with the barrier 10 to slow the spread of the contaminant 12.

The source 18 may comprise a generator adapted to provide a continuous low-voltage negative electric potential at each of the plurality of electrically conductive surfaces 20. Alternatively, the source 18 may be a solar cell or battery, or may use a combination of metals to produce the low-voltage electric charge. One such method of generating a charge which is common to those in the art is the use of a sacrificial anode 24, which provides a low-voltage electrical potential to a cathode surface 20 as described in U.S. Pat. No. 2,645,612.

With reference now to FIG. 2, the barrier 10 is shown as would be utilized in surface water 26 and/or sediment 28. In FIG. 2, the plurality of electrically conductive surfaces 20 comprises a plurality of wires 30. As shown, the barrier further comprises a bioreactive material port 32, through which bioreactive material beneficial to remediation may be provided.

Biological compounds, such as a sulfate-reducing bacteria (SRBs) or other bioreactive materials, may be provided in situ at one or more of the bioreactive material ports 32. As shown in FIG. 2, this port 32 may comprise a tube 34. The bioreactive material port 32, as shown, may provide bioreactive material in situ through gravitational force, pressure differential or external force provided by a pump 36 or other similar means. It should be noted that many SRBs, and other bioreactive materials, may be preexisting in situ in quantities which make reduction of contaminants 12 possible. Thus, use of the bioreactive port 32 particularly, or use of added biological material in general, may be determined by the conditions in the area to be treated.

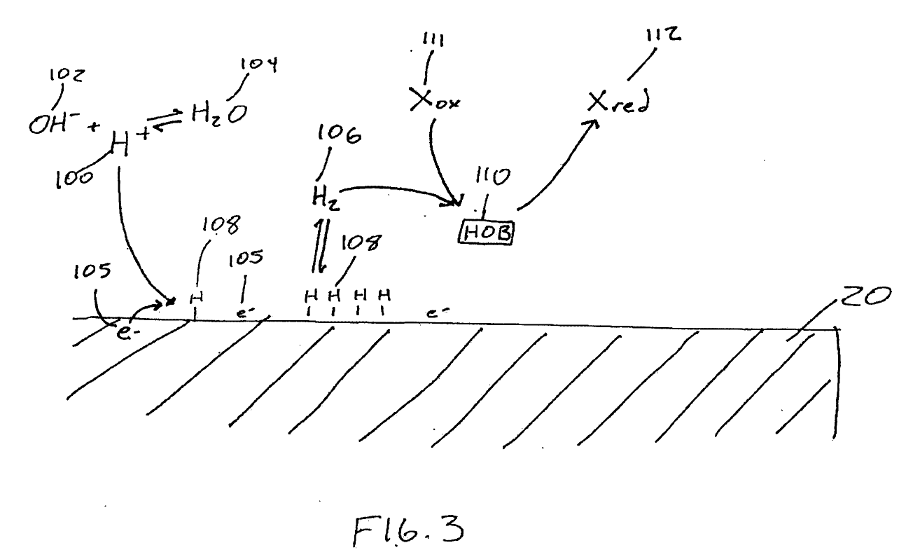

Turning now to FIG. 3, the electrically conductive surfaces 20 provide a location for the formation of dissolved hydrogen molecules in water. A low negative electric charge is provided at the electrically conductive surface 20, attracting positively charged aqueous hydrogen ions 100 which exist naturally in equilibrium with hydroxide ions 102 and water molecules 104. Two hydrogen ions 102, in proximity to the negatively charged surface, may bond utilizing donated electrons 105 from the surface to form a hydrogen molecule 106. Low concentrations of hydrogen molecules 106 are soluble in water, thus the hydrogen molecules formed will be dissolved in surrounding water.

The dissolved hydrogen 106 is formed by creating a mono-layer 108 intermediate at the cathode surface 20. Hydrogen molecules 106 are then removed to solution. The removal may take place as a result of equilibrium-driven dissolution and/or action of microbes existing in solution. Some removal may also take place due to formation of bubbles. Some species of anaerobic microorganisms, notably sulfate-reducing bacteria (SRBs) 110 contain hydrogenases which allow the organisms to remove the hydrogen film 108 and utilize hydrogen 106 as an energy source. These organisms then transfer hydrogen ions 100 and electrons 105 to a reducible species.

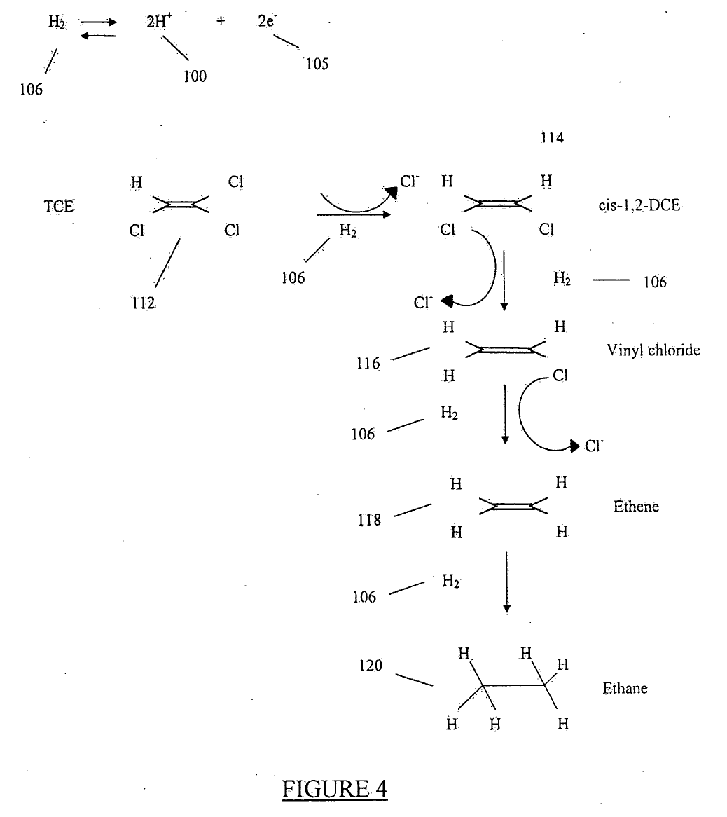

The presence of dissolved hydrogen molecules 106 has been shown to attract naturally-occurring or introduced biological compounds and induce the reduction of contaminants by the compounds into a more inert form. Turning now to FIG. 4, one such reduction reaction is shown in written form. Dissolved hydrogen 106 can be reduced to hydrogen ions 100 and electrons 105 by the hydrogenase properties of the biological material. As shown, the ions 100 and electrons 105 are then utilized to convert trichloroethene 112 to ethene and ethane. The trichloroethene 112, in the presence of hydrogen ions 100 and excess electrons 105, is converted to cis- and trans-dichloroethene 114. The continued presence of hydrogen ions 105 in a negatively charged solution reduces the dichloroethene 114 to vinyl chloride 116 and finally ethene 118. Ethene 118 may be further reduced to ethane 120 in the presence of excess hydrogen ions 100.

While trichloroethane 112 is utilized in FIG. 4 for exemplary purposes, any number of reducible species may be remediated through this process. For example, other halogenated hydrocarbons such as PCP or chloromethanes may accept electrons 105, as will reducible compound such as nitrates, chromium, uranium, perchlorates, and MTBE.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. A method for producing dissolved hydrogen molecules for bioremediation of water, the method comprising:
providing an electrically conductive surface;
providing a continuous negative electric potential to the electrically conductive surface to attract aqueous hydrogen ions; and
converting aqueous hydrogen ions to the dissolved hydrogen molecules using the electron source provided by the negative electric potential.

2. The method of claim 1 further comprising the step of providing a bioreactive material proximate the electrically conductive surface.

3. The method of claim 1 wherein the electrically conductive surface is underground.

4. A method for bioremediation of a contaminant plume in water, the method comprising:
producing dissolved hydrogen, wherein producing dissolved hydrogen comprises the steps of:
providing an electrically conductive surface;
providing a continuous negative electric potential to the electrically conductive surface;
attracting aqueous hydrogen ions to the electrically conductive surface;
forming dissolved hydrogen molecules proximate the surface from the aqueous hydrogen ions; and
providing a bioreactive material proximate the conductive surface to facilitate bioremediation of the contaminant plume.

5. The method of claim 4 wherein the contaminant plume is in soil.

6. The method of claim 4 wherein the contaminant plume is in sediment.

7. The method of claim 4 wherein the contaminant plume is in a treatment vessel.

8. A method for reducing a halogenated organic compound in an aqueous plume, the method comprising:
providing a plurality of underground electrically conductive surfaces;
producing a continuous negative electric potential at the conductive surface, such that the negative electric potential increases a concentration of aqueous hydrogen proximate at least one of the plurality of surfaces;
causing the aqueous hydrogen ions to form dissolved hydrogen molecules proximate the at least one surface; and
providing a bioreactive material to the plume proximate the at least one surface to reduce the halogenated organic compound.

9. The method of claim 8 wherein the halogenated organic compound is a chloroethene.

10. The method of claim 9 wherein the halogenated organic compound is reduced through interaction with the bioreactive material to ethene and ethane.

11. The method of claim 8 further comprising the step of adding nutrients proximate the length, wherein the nutrients attract the biological material.

12. The method of claim 8 wherein the length comprises a pylon.

13. The method of claim 8 wherein the length comprises a cable.

14. The method of claim 8 wherein the length comprises a lattice grid.

15. The method of claim 8 wherein the bioreactive material comprises bacteria.

16. The method of claim 15 wherein the bacteria is adapted to convert the halogenated organic compound to ethane and ethene.

17. The method of claim 15 wherein the bioreactive material further comprises nutrients.

18. The method of claim 15 wherein the bacteria is adapted to local environmental conditions.

19. The method of claim 15 wherein the bacteria is adapted to reduce the halogenated organics.

20. A barrier for treating an aqueous contaminant plume by providing a location for aqueous hydrogen ions to form dissolved hydrogen molecules, the barrier comprising:
a plurality of electrically conductive surfaces; and
a means for generating a low voltage negative electrical charge at a selected plurality of conductive surfaces.

21. The barrier of claim 20 further comprising a means for providing bioreactive material proximate the electrically conductive surfaces.

22. The barrier of claim 21 wherein the means for providing bioreactive material comprises a bioreactive material port.

23. The barrier of claim 20 wherein the conductive surfaces comprise pylons.

24. The barrier of claim 20 wherein the electrically conductive surfaces are disposed in a portion of a single planar arrangement.

25. The barrier of claim 24 wherein the single planar arrangement is within a single vertical plane.

26. The barrier of claim 20 wherein a portion of the electrically conductive surfaces are disposed in a first planar arrangement and wherein a second portion of the electrically conductive surfaces are disposed in a second planar arrangement, wherein the second planar arrangement is parallel to the first planar arrangement and wherein the surfaces in the second planar arrangement are disposed to alternate with the surfaces in the first planar arrangement.

27. A barrier for treating an aqueous contaminant plume comprising:
a low-voltage electric source; and
a plurality of electrically conductive surfaces, wherein the plurality of conductive surfaces are adapted to receive a low-voltage negative charge from the source and wherein the plurality of surfaces provide electrons to aqueous hydrogen ions proximate the surface.

28. The barrier of claim 27 wherein at least one of the plurality of underground electrically conductive surfaces comprises a bioreactive material delivery port.

29. The barrier of claim 27 wherein the contaminant plume comprises halogenated organics.

30. The barrier of claim 27 wherein the contaminant plume comprises reducible inorganic compounds.

31. The barrier of claim 27 wherein the contaminant plume comprises perchlorate.
